(19) United States
(12) Patent Application Publication
(10) Pub. No.: US 2025/0063226 A1
(43) Pub. Date: Feb. 20, 2025

(54) EFFECT DISPLAY METHOD, ELECTRONIC DEVICE AND STORAGE MEDIUM

(71) Applicant: Beijing Zitiao Network Technology Co., Ltd., Beijing (CN)

(72) Inventors: Jiacheng LIU, Beijing (CN); Xing GAO, Beijing (CN); Jianrong MA, Beijing (CN)

(21) Appl. No.: 18/809,110

(22) Filed: Aug. 19, 2024

(30) Foreign Application Priority Data
Aug. 18, 2023 (CN) 202311049111.7

(51) Int. Cl. H04N 21/45; H04N 21/44; H04N 21/472; H04N 21/4788

(52) U.S. Cl. CPC H04N 21/4532; H04N 21/44012; H04N 21/47205; H04N 21/4788

(57) ABSTRACT

The embodiments of the present disclosure provide an effect display method and apparatus, an electronic device and a storage medium, the corresponding custom asset file is acquired in response to the triggering of the target effect; the target effect is configured to display at least one frame of effect image; the custom asset file is loaded through the resource reference interface of the target effect to obtain the association relationship list corresponding to the target effect; and according to the association relationship list, corresponding association relationship information is acquired from the server, and the corresponding effect image is generated based on the association relationship information, and the association relationship information represents the user identifier of the associated user having the association relationship with the current user. The custom asset file is utilized to achieve the decoupling of the step of acquiring the user information.

### CROSS-REFERENCE TO RELATED APPLICATION

The present application claims priority of the Chinese Patent Application No. 202311049111.7, filed on Aug. 18, 2023, and the disclosure of the above-mentioned Chinese patent application is hereby incorporated in its entirety as a part of the present application.

### TECHNICAL FIELD

Embodiments of the present disclosure relate to an effect display method and apparatus, an electronic device and a storage medium.

### BACKGROUND

Currently, adding virtual elements such as virtual objects and pre-shot photos to videos is one of the common video effect functions in video applications and platforms. On this basis, the social attribute of the video effect can be further improved by calling the association relationship information in the process of video effect implementation to generate the video effect based on the association relationship information.

In some technologies, for such video effects based on the association relationship information, it is needed to acquire the corresponding association relationship information from a server. Therefore, for the video effects based on the association relationship information, it is needed to bind an association relationship information acquisition interface on the server at the code level, which leads to that this type of video effects based on the association relationship information can only be designed by development users of the video applications and platforms, and cannot be designed personally by general users, thereby resulting in high development cost and poor use flexibility of this type of video effects.

### SUMMARY

The embodiments of the present disclosure provide an effect display method and apparatus, an electronic device and a storage medium, to overcome the problems of high development cost and poor use flexibility of video effects based on association relationship information.

The embodiments of the present disclosure provide an effect display method, which includes:
in response to triggering of a target effect, acquiring a corresponding custom asset file, wherein the target effect is configured to display at least one frame of effect image; loading the custom asset file through a resource reference interface of the target effect to obtain an association relationship list corresponding to the target effect, and acquiring corresponding association relationship information from a server according to the association relationship list, and the association relationship information represents a user identifier of an associated user having an association relationship with the current user; and generating a corresponding effect image based on the association relationship information.

The embodiments of the present disclosure provide an effect display apparatus, which includes:
an acquisition module, configured to, in response to triggering of a target effect, acquire a corresponding custom asset file, wherein the target effect is configured to display at least one frame of effect image;
a loading module, configured to load the custom asset file through a resource reference interface of the target effect to obtain an association relationship list corresponding to the target effect, and acquire corresponding association relationship information from a server based on the association relationship list, and the association relationship information represents a user identifier of an associated user having an association relationship with the current user; and
a generation module, configured to generate a corresponding effect image based on the association relationship information.

The embodiments of the present disclosure provide an electronic device, which includes a processor and a memory, the memory stores a computer execution instruction; and the processor executes the computer execution instruction stored in the memory, so that the processor implements the above effect display method and various possible designed effect display methods of the above effect display method.

The embodiments of the present disclosure provide a computer-readable storage medium, the computer-readable storage medium stores a computer execution instruction that, when executed by a processor, causes the processor to implement the above effect display method and various possible designed effect display methods of the above effect display method.

The embodiments of the present disclosure provide a computer program product, which includes a computer program that, when executed by a processor, causes the processor to implement the above effect display method and various possible designed effect display methods of the above effect display method.

### BRIEF DESCRIPTION OF DRAWINGS

To describe the technical solutions in the embodiments of the present disclosure or in the prior art more clearly, the accompanying drawings required in the description of the embodiments or the prior art will be described briefly below, apparently, the accompanying drawings in the following description are some embodiments of the present disclosure, other accompanying drawings can also be obtained according to these drawings without creative labor by those ordinarily skilled in the art.

FIG. 1 is an application scene diagram of an effect display method provided by an embodiment of the present disclosure;

FIG. 2 is a flowchart 1 of an effect display method provided by an embodiment of the present disclosure;

FIG. 3 is a flowchart of specific implementation steps of acquiring corresponding association relationship information from a server based an association relationship list;

FIG. 4 is a flowchart 2 of an effect display method provided by an embodiment of the present disclosure;

FIG. 5 is a schematic diagram of a mapping relationship from a custom asset file to an effect image provided by an embodiment of the present disclosure;

FIG. 6 is a flowchart of specific implementation steps of a step S203 in an embodiment illustrated in FIG. 4;

FIG. 7 is a schematic diagram of one type of first relationship data provided by an embodiment of the present disclosure;

FIG. 8 is a schematic diagram of another type of first relationship data provided by an embodiment of the present disclosure;

FIG. 9 is a flowchart of specific implementation steps of a step S205 in an embodiment illustrated in FIG. 4;

FIG. 10 is a schematic diagram of target association relationship information provided by an embodiment of the present disclosure;

FIG. 11 is a structural block diagram of an effect display apparatus provided by an embodiment of the present disclosure;

FIG. 12 is a structural schematic diagram of an electronic device provided by an embodiment of the present disclosure; and

FIG. 13 is a hardware structure schematic diagram of an electronic device provided by an embodiment of the present disclosure.

### DETAILED DESCRIPTION

In order to make the purpose, technical scheme and advantages of the embodiment of the present disclosure clearer, the technical schemes in the embodiments of the present disclosure will be described clearly and completely with the accompanying drawings, obviously, the described embodiments are a part of the embodiments of the present disclosure, but not all embodiments. Based on the embodiments of the present disclosure, all other embodiments obtained by those ordinarily skilled in the art without creative labor belong to the protection scope of the present disclosure.

It should be noted that the user information (including but not limited to user device information, user personal information, etc.) and data (including but not limited to data for analysis, stored data, displayed data, etc.) involved in the present disclosure are all information and data authorized by users or fully authorized by all parties, and the collection, using and processing of relevant data need to comply with relevant laws, regulations and standards of relevant countries and regions, and corresponding operation portals are provided for users to choose authorization or rejection.

The following describes application scenes of the embodiments of the present disclosure.

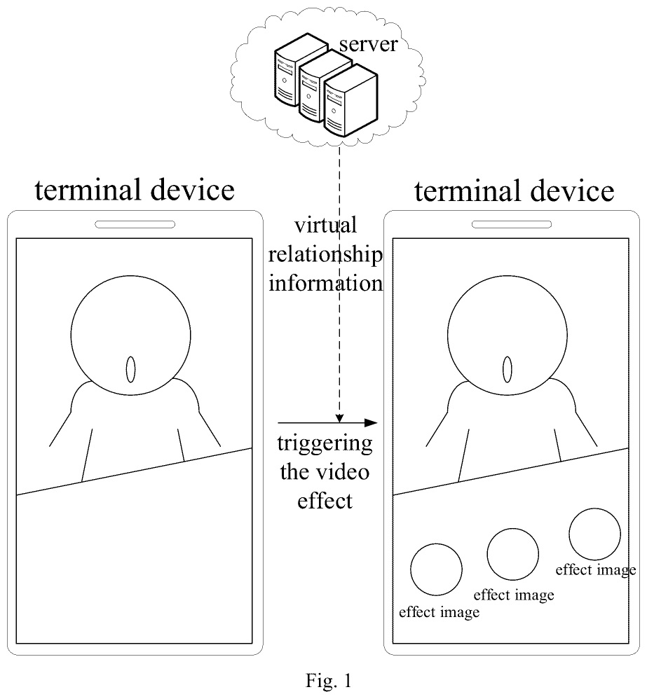

FIG. 1 is an application scene diagram of an effect display method provided by an embodiment of the present disclosure; and the effect display method provided by the embodiment of the present disclosure can be applied to an application with a video effect editing function, and more specifically, can be applied to editing and using scenes of video effects based on association relationship information. An execution subject according to this embodiment can be a terminal device which runs the above application with the video effect editing function, or a server which runs a service terminal corresponding to the above application, or other electronic devices with similar functions. As shown in FIG. 1, taking the terminal device as an example, the terminal device loads a video effect in the application based on an operation of a user, and the video effect can be a custom effect created through other applications or platforms. And then, the terminal device inserts an effect image into an initial video through triggering the video effect, so as to generate an effect video with the effect image. The effect image generated by the video effect is generated based on the association relationship information of a current user (such as a user logging in the current application), and specifically, the effect image is, for example, generated based on related images and identifiers of an associated user followed by the current user. The association relationship information needs to be downloaded from the server based on the request and permission of the user while the terminal device triggers the custom effect.

In the prior art, this type of video effect based on the association relationship information can be realized only by acquiring corresponding association relationship information from the server; therefore, for the video effect based on the association relationship information, it is needed to bind an association relationship information acquisition interface on the server at the code level, so that the required user information can be acquired through the interface in response to the effect being triggered. It is difficult to bind the association relationship information acquisition interface for the video effect at the code level, the operation threshold is high, which leads to that, generally, this type of video effect based on the association relationship information can only be designed by development users of video editing applications and platforms, and cannot be designed personally by general users, thereby resulting in high development cost and poor use flexibility of this type of video effects.

An embodiment of the present disclosure provides an effect display method to solve the problems above.

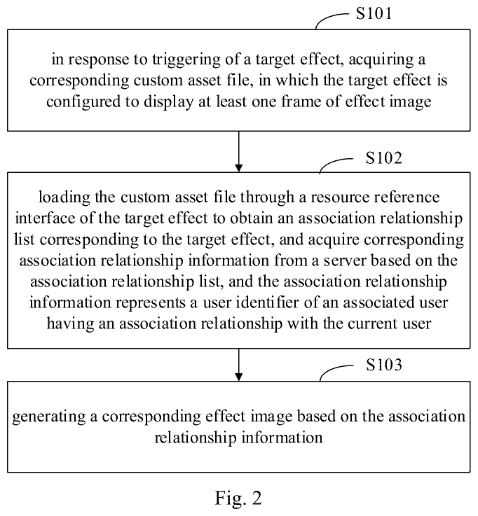

Referring to FIG. 2, FIG. 2 is a flowchart 1 of an effect display method provided by an embodiment of the present disclosure. The method according to this embodiment can be applied to a terminal device, and the effect display method includes:

Step S101: in response to triggering of a target effect, acquiring a corresponding custom asset file, in which the target effect is configured to display at least one frame of effect image.

Exemplarily, with reference to the application scene schematic diagram shown in FIG. 1, after the terminal device runs an application with a video editing function, firstly an original video to be processed is loaded, and then a corresponding target effect is selected based on a user instruction, so as to be loaded into the original video, and generate a video including the effect (namely the target video referred to below in this embodiment). The target effect in this embodiment is configured to display at least one frame of effect image in the original video, and specifically, for example, displaying a single-frame image in the original video, specifically, for example, a png picture, or displaying a dynamic image in the original video, specifically, for example, a sequence frame. Further, the effect image generated by the target effect is generated based on the association relationship information of the current user, and the association relationship information represents the user identifier of the associated user having the association relationship with the current user. The current user is, for example, a user logging in the application or platform, and the associated user of the current user is a user having an association relationship with the current user, for example, a user registering in the application or platform and following the current user; for another example, a user registering in the application or platform and followed by the current user; and for yet another example, a user registering in the application or platform and being a fan of the current user. In addition to the above implementation mode, the specific definition and implementation of the associated user also include other modes, which can be set according to service requirements, and specific limitation is not made here. And the user identifier of the associated user is, for example, a registry name, a registration ID, a user identification code, a nickname, and an avatar of the associated user (on the above-mentioned application or platform).

Further, after the target effect is triggered, the terminal device needs to acquire the association relationship information corresponding to the current user in order to generate the above effect image based on the association relationship information of the current user, and the terminal device determines and acquires a custom asset file corresponding to the target effect so as to achieve the above purposes. Specifically, the terminal device can determine a corresponding effect file or folder according to the name (unique identification identifier) of the target effect, and then acquire the custom asset file corresponding to the target effect through the effect file or folder. The custom asset file is a data format obtained by encapsulating based on a specific framework; the custom asset file has a specific data structure and file suffix; the purpose of acquiring the user information can be achieved by loading and running the custom asset file; and the compiling mode and the data structure of the custom asset file are not specifically limited in this embodiment. After the target effect (the corresponding program script) is executed by the application ran by the terminal device, the custom asset file can be loaded and utilized, so that the purpose of acquiring the user information is achieved.

In a possible implementation mode, the target effect is a custom effect, that is, an effect template having custom model and effect, which is set by the effect development user according to needs and preferences based on other effect software. The effect development user can set a pre-generated custom asset file in a project file of the target effect during developing the target effect, so as to realize the binding between the target effect and the custom asset file, and then the terminal device can accurately acquire and call the custom asset file corresponding to the target effect in the subsequent process of triggering the target effect. The custom asset file is equivalent to encapsulation of “function of acquiring association relationship information”; the effect development user can generate the target effect of the effect image based on the association relationship information through setting the custom asset file, and does not need to realize the “function of acquiring association relationship information” at the code level, so that the development difficultly in generating the target effect of the effect image based on the association relationship information is greatly reduced, and the “social relationship effect” (namely the target effect) which has such program structure and is realized based on such program structure has better diversity and flexibility.

Step S102: loading the custom asset file through a resource reference interface of the target effect to obtain an association relationship list corresponding to the target effect, and acquire corresponding association relationship information from a server based on the association relationship list, and the association relationship information represents a user identifier of an associated user having an association relationship with the current user.

Exemplarily, after the custom asset file is acquired, the resource reference interface of the target effect is utilized to load the custom asset file, so as to realize the utilization of the custom asset file; specifically, the data in the custom asset file is acquired, and the processing logic in the custom asset file is executed, thus the association relationship list corresponding to the target effect is acquired, and the corresponding association relationship information is acquired from the server based on the association relationship list, such as the nickname and the avatar of the associated user. The association relationship list is a set of the association relationship information corresponding to a plurality of associated users; and the number of the corresponding association relationship information in the association relationship list is determined through the data included in the custom asset file after the custom asset file is loaded, that is, the number of the corresponding association relationship information in the association relationship list is determined based on the custom asset file.

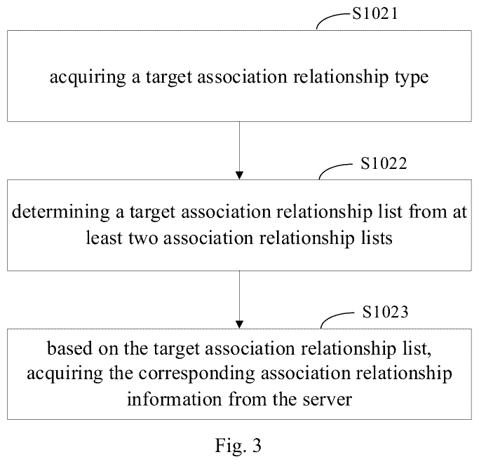

In a possible embodiment, as shown in FIG. 3, the specific implementation mode of acquiring the corresponding association relationship information from the server based on the association relationship list in step S102 includes:

Step S1021: acquiring a target association relationship type.

Step S1022: determining a target association relationship list from at least two association relationship lists.

Step S1023: based on the target association relationship list, acquiring the corresponding association relationship information from the server.

Exemplarily, the association relationship type represents the relationship type between the current user and the associated user corresponding to the current user, for example, the association relationship type includes “following user”, namely, the associated user corresponding to the association relationship information in the association relationship list follows the current user; for another example, the association relationship type includes “followed user”, namely, the associated user corresponding to the association relationship information in the association relationship list is followed by the current user; and for yet another example, the association relationship type includes “fan user”, namely, the associated user corresponding to the association relationship information in the association relationship list is a fan of the current user.

Correspondingly, different association relationship types have corresponding association relationship lists, for example, for the “following user”, there is a corresponding association relationship list_1, and for the “followed user”, there is a corresponding association relationship list_2, the list type corresponding to the association relationship list (namely information in one-to-one correspondence with the association relationship types) can be obtained by reading type attribute of the association relationship list. Further, in one possible implementation mode, the association relationship type can be fixedly corresponding to the target effect, for example, for a target effect A, the corresponding association relationship type is the “followed user”; for a target effect B, the corresponding association relationship type is the “fan user”; in another possible implementation mode, the association relationship type can be set by the user before the target effect is triggered. No matter which implementation mode is used, after the target effect is triggered, the terminal device can acquire a type identifier representing the association relationship type, and then determine the target association relationship type based on the type identifier; and then, a target association relationship list corresponding to the target association relationship type can be obtained from a plurality of association relationship lists, which are obtained by loading the custom asset file through the resource reference interface. And then, based on the record data in the target association relationship list, corresponding association relationship information is acquired from the corresponding storage position of the server. In one possible implementation mode, the record data in the target association relationship list includes a server address and a storage position for storing the corresponding association relationship information, and by downloading data through the server address and the storage position of the association relationship information in the record data, the association relationship information can be obtained.

Step S103: generating a corresponding effect image based on the association relationship information.

Exemplarily, after the association relationship information is obtained, corresponding processing is carried out based on the association relationship information, so as to generate the corresponding effect image. Specifically, for example, in response to the association relationship information being an associated user avatar, processing steps such as down-sampling, blurring or adding virtual article sticker can be carried out on the basis of the associated user avatar, and then the effect image is generated. For example, in response to the association relationship information being the user name (character), the user name can be rendered into a nickname image, and then the nickname image is processed, for example, as described above to generate the effect image. The two implementation modes can be executed independently or simultaneously, and no specific limitation is made in this embodiment.

Optionally, the generated effect image is rendered into the original video, so that effect preview of the target video can be realized, or the target video including the effect image is outputted, and the process of adding the target effect to the original video is realized. And then, optionally, the generated target video can be further processed, for example, the generated target video can be released to the server (namely released to the application or platform), or the target video can be stored, and shared.

In this embodiment, the corresponding custom asset file is acquired in response to the triggering of the target effect; the target effect is configured to display at least one frame of effect image, and the effect image is an image generated based on the association relationship information of the current user; and the association relationship information represents the user identifier of the associated user having the association relationship with the current user; the custom asset file is loaded through the resource reference interface of the target effect to obtain the association relationship list corresponding to the target effect; and according to the association relationship list, corresponding association relationship information is acquired from the server, and the corresponding effect image is generated based on the association relationship information. After the target effect based on the association relationship information is triggered, the custom asset file is loaded, and the capability provided by the custom asset file is utilized to obtain the association relationship list corresponding to the target effect, and the user information is acquired from the server based on the association relationship list, so that the effect image corresponding to the target effect can be generated based on the user information. Because the custom asset file is utilized to achieve the decoupling of the step of acquiring the user information, it is not needed to consider the specific implementation mode of acquiring the association relationship information in the design stage of the target effect, the design difficulty of the target effect based on the association relationship information is reduced, the development cost is reduced, and the diversity and flexibility of the target effect are improved.

Referring to FIG. 4, FIG. 4 is a flowchart 2 of an effect display method provided by an embodiment of the present disclosure. According to this embodiment, step S102 is further refined on the basis of the embodiment in FIG. 2, and the effect display method includes:

Step S201: in response to the triggering of the target effect, acquire the corresponding custom asset file, in which the target effect is configured to display at least one frame of effect image.

Step S202: loading the custom asset file from the project file corresponding to the target effect through the resource reference interface of the target effect, so as to obtain at least one association relationship resource object and an image model corresponding to the association relationship resource object, in which the association relationship resource object is configured to provide the association relationship information for the effect image corresponding to the image model.

Exemplarily, the target effect corresponds to a project including a plurality of project files, and the custom asset file is preset in the project of the target effect; after the target effect is triggered, the custom asset file is loaded from the project file through the resource reference interface of the target effect, that is, in the program structure of the target effect, the execution program of the target effect and the program for acquiring the user information are decoupled, and the custom asset file is loaded through the resource reference interface for the target effect, so that the association relationship information required for subsequently generating the effect image is obtained. Specifically, after the custom asset file is loaded, an association relationship resource object can be generated in the terminal device, and the association relationship resource object can be an instantiation result of a certain category in the custom asset file. The association relationship resource object has attribute corresponding the image model, and the purpose of providing the association relationship information for the effect image corresponding to the image model is finally achieved through the association relationship resource object. And then, the association relationship list corresponding to the target effect is obtained according to the association relationship resource object and the corresponding image model.

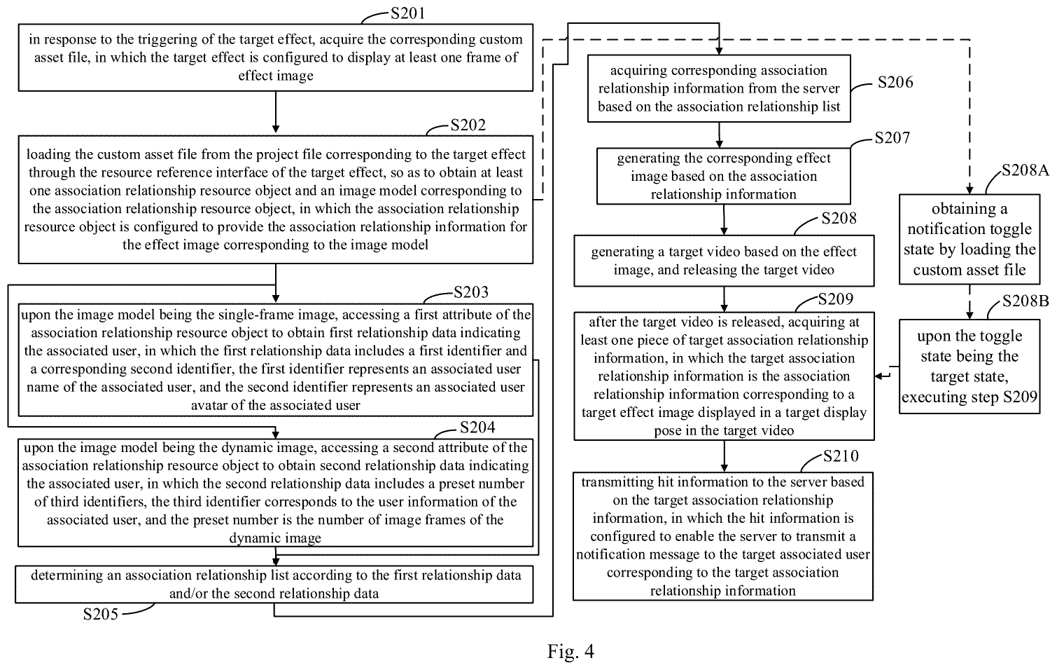

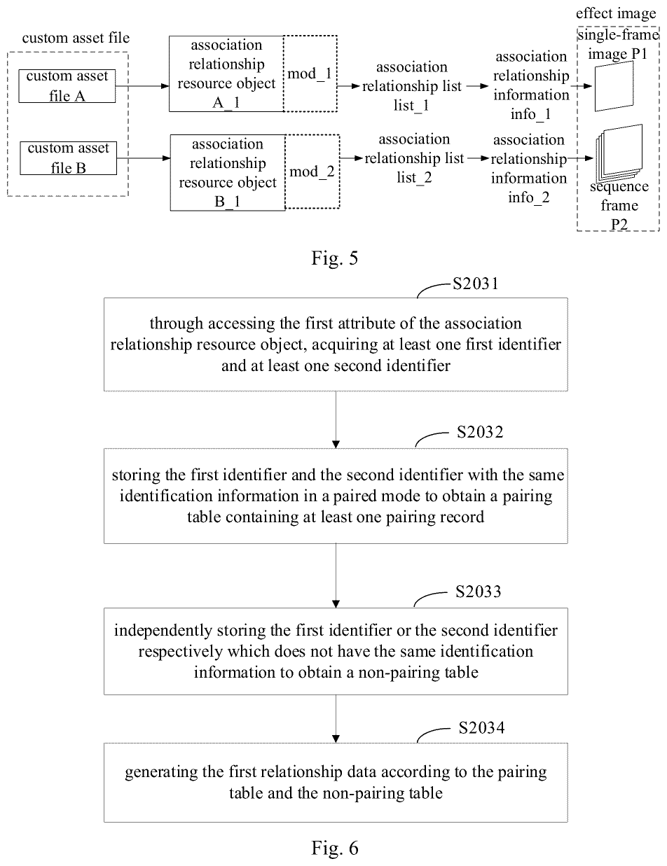

Exemplarily, the image model corresponding to the association relationship resource object at least includes a single-frame image and a dynamic image, the single-frame image is, for example, a png picture, and the dynamic image is, for example, a sequence frame. That is, an effect image of the corresponding type can be generated through the association relationship resource object corresponding to the image model. FIG. 5 is a schematic diagram of a mapping relationship from a custom asset file to an effect image provided by an embodiment of the present disclosure; as shown in FIG. 5, after a custom asset file A is loaded, an association relationship resource object A_1 and a corresponding image model mod_1 (shown as mod_1 in the figure) are obtained, and the image model mod_1 represents the single-frame image; then a corresponding association relationship list list_1 is generated based on the association relationship resource object A_1 and the corresponding image model mod_1; and then, based on an association relationship list list_1, association relationship information info_1 meeting the generation requirement of the single-frame image is acquired from the server, and a corresponding single-frame image P1 (P1.Png) is generated, namely, an effect image corresponding to the custom asset file A; on the other hand, after the custom asset file B is loaded, an association relationship resource object B_1 and a corresponding image model mod_2 are obtained, and the image model mod_2 represents the sequence frame (namely the dynamic image including the multi-frame pictures); then, a corresponding association relationship list list_2 is generated based on the association relationship resource object B_1 and the corresponding image model mod_2; and then, based on an association relationship list list_2, association relationship information info_2 meeting the generation requirement of the sequence frame is acquired from the server, and a corresponding sequence frame P2 (png-seq, namely a set of a plurality of images) is generated, namely the effect image corresponding to the custom asset file B. And the single-frame image P1 and the sequence frame P2 are the target effect images corresponding to the target effect.

Further, the image model corresponding to the association relationship resource object can be determined according to the suffix of the custom asset file in response to the custom asset file being loaded. The specific implementation steps of obtaining the association relationship list corresponding to the target effect according to the association relationship resource object and the corresponding image model are introduced below in detail.

Step S203: in response to the image model being the single-frame image, accessing a first attribute of the association relationship resource object to obtain first relationship data indicating the associated user, in which the first relationship data includes a first identifier and a corresponding second identifier, the first identifier represents an associated user name of the associated user, and the second identifier represents an associated user avatar of the associated user.

Exemplarily, the association relationship resource object has a plurality of accessible attributes, and the attributes of the association relationship resource object can be accessed through corresponding preset interfaces. In response to the image model being the single-frame image, the first attribute of the association relationship resource object is accessed to obtain the first relationship data representing the association relationship information, and the first relationship data is the user information required for generating the effect image of the single-frame image type. Specifically, the first relationship data includes the first identifier and the corresponding second identifier, the first identifier represents the associated user name of the associated user, and the second identifier represents the associated user avatar of the associated user.

Exemplarily, as shown in FIG. 6, the specific implementation mode of step S203 includes:

Step S2031: through accessing the first attribute of the association relationship resource object, acquiring at least one first identifier and at least one second identifier.

Step S2032: storing the first identifier and the second identifier with the same identification information in a paired mode to obtain a pairing table containing at least one pairing record.

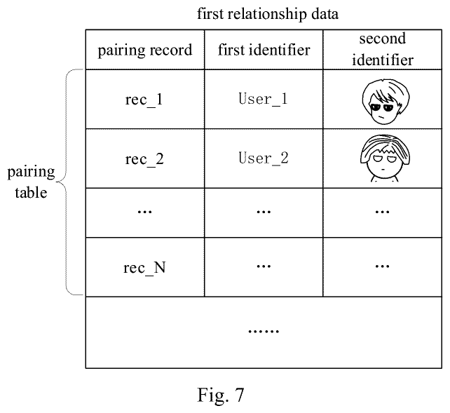

FIG. 7 is a schematic diagram of one type of first relationship data provided by an embodiment of the present disclosure; as shown in FIG. 7, the first relationship data is composed of the pairing table, and the pairing table includes N pairing records which are respectively pairing records rec_1 to rec_N; each pairing record includes one first identifier and one corresponding second identifier, the first identifier is the user nickname (such as User_1 and User_2 shown in the figure) of the associated User, and the second identifier is the avatar of the associated user; each pairing record corresponds to unique identification information and is configured to represent one user; in response to the first attribute of the association relation resource object being accessed, the association relationship resource object respectively acquires the at least one first identifier and at least one second identifier by accessing the server, and then pairing is carried out based on the identification information corresponding to the first identifier and the identification information corresponding to the second identifier, the identifiers with the same identification information form one pairing record, so that the above pairing table is generated.

Exemplarily, in one possible implementation mode, after the pairing table is obtained, the first relationship data can be directly generated according to the pairing table, that is, the first relationship data only includes the first identifier and the second identifier which are paired. In response to the effect image being generated subsequently based on the first relationship data, the effect image with the first identifier (user nickname) and the second identifier (associated user avatar) at the same time can be generated. In another possible implementation mode, a non-pairing table can be further obtained, and the first relationship data is generated based on the pairing table and the non-pairing table together.

Step S2033: independently storing the first identifier or the second identifier respectively which does not have the same identification information to obtain a non-pairing table.

Step S2034: generating the first relationship data according to the pairing table and the non-pairing table.

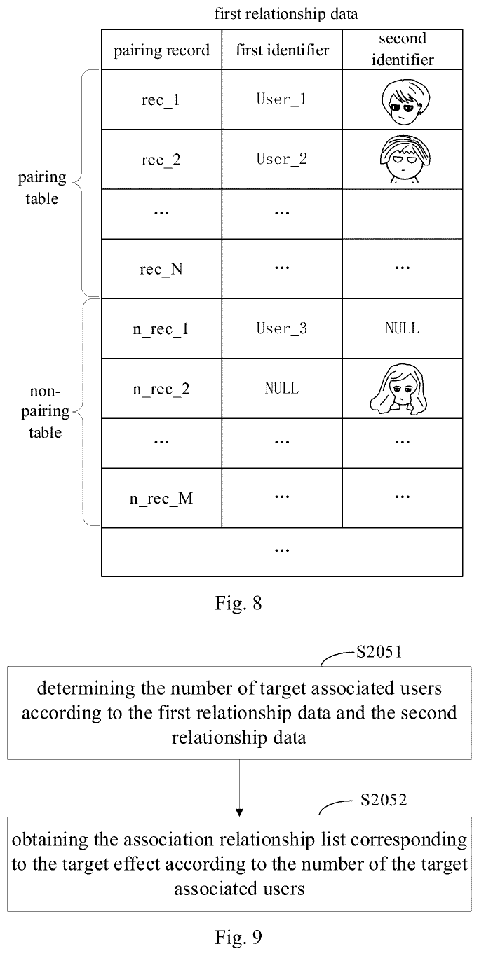

Exemplarily, similarly, in response to the first identifier and the second identifier which are paired being obtained according to the identification information, and a pairing record only including one identifier (the first identifier or the second identifier) is generated through the first identifier or the second identifier which are not paired, so as to obtain the non-pairing table. Then the pairing table and the non-pairing table are combined to jointly generate the first relationship data. In response to the effect image being generated subsequently based on the first relationship data, the effect image only including the first identifier (the user nickname) or the second identifier (the associated user avatar) can be generated. FIG. 8 is a schematic diagram of another type of first relationship data provided by an embodiment of the present disclosure; and as shown in FIG. 8, the first relationship data is composed of the pairing table and the non-pairing table, and the specific meaning of the pairing table is introduced in the embodiment shown in FIG. 7, which is not described in detail here. The non-pairing table includes pairing records n_rec_1 to n_rec_M, and each pairing record only includes the first identifier (the user nickname) or the second identifier (the associated user avatar). For example, as shown in the figure, the pairing record n_rec_1 includes a user nickname User_3 and does not include the associated user avatar (represented by NULL, the same below); and the pairing record n_rec_2 includes the associated user avatar but does not include the user nickname.

Then, in a possible implementation mode, the pairing table and the non-pairing table are combined to form the first relationship data, and the association relationship list corresponding to the target effect can be generated according to each pairing record in the first relationship data.

Step S204: in response to the image model being the dynamic image, accessing a second attribute of the association relationship resource object to obtain second relationship data indicating the associated user, in which the second relationship data includes a preset number of third identifiers, the third identifier corresponds to the user information of the associated user, and the preset number is the number of image frames of the dynamic image.

Exemplarily, in another possible implementation mode, in response to the image model of the association relationship resource object being the dynamic image, such as the sequence frame, the association relationship resource object has the second attribute; and the second attribute of the association relationship resource object can be accessed to obtain the second relationship data, the second relationship data includes a preset number of third identifiers representing the number of image frames of the dynamic image. Exemplarily, the third identifier represents an image including the associated user name and the associated user avatar, that is, each third identifier corresponds to one piece of association relationship information, and the number (preset number) of the third identifiers in the second relationship data is the number of image frames (sequence length in the sequence frame) corresponding to the dynamic image. The specific implementation mode, of accessing the second attribute of the association relationship resource object to obtain the second relationship data, is similar to the specific implementation mode of accessing the first attribute of the association relationship resource object to obtain the first relationship data, the previous introduction can be referred, which is not described in detail here.

Further, in a possible implementation mode, after the second relationship data is obtained, the association relationship list corresponding to the target effect can be generated according to the second relationship data, the specific implementation mode is similar to the mode of generating the association relationship list based on the first relationship data, which is not described in detail here.

Step S205: determining an association relationship list according to the first relationship data and/or the second relationship data.

Exemplarily, based on the above introduction, the association relationship list can be generated independently based on the first relationship data or the second relationship data, and the specific implementation mode depends on the custom asset file corresponding to the target effect, specifically, for example, the target effect only corresponds to (generates) one effect image, the corresponding first relationship data or second relationship data can be obtained according to the image type of the effect image, namely the image model (the single-frame image or sequence frame) corresponding to the association relation resource object. And then, the corresponding association relationship list is obtained based on the obtained first relationship data or second relationship data, thereby realizing the effect image of the corresponding category.

Exemplarily, in another possible implementation mode, in response to the target effect corresponding to (generating) more than one effect image, and the image models corresponding to the effect images being different, the association relationship list can be determined according to the first relationship data and the second relationship data together.

Exemplarily, as shown in FIG. 9, the specific implementation mode of step S205 includes:

Step S2051: determining the number of target associated users according to the first relationship data and the second relationship data.

Step S2052: obtaining the association relationship list corresponding to the target effect according to the number of the target associated users.

Firstly, the number of the target associated users is determined according to the first relationship data and the second relationship data, and the number of the target associated users is the number of the associated users set in the association relationship list. For example, a current user User_1 has 100 associated users in total, 10 associated users are determined based on the first relationship data and the second relationship data, then the corresponding association relationship list is generated, corresponding user information is obtained subsequently, and the effect image is generated. 10 in the above example is the number of the target associated users. And then, based on the determined number of the target associated users, the target associated users with the target associated user number are selected from all the associated users of all the current users in a specific manner, and thus the association relationship list corresponding to the target effect can be generated.

Exemplarily, the specific implementation mode of step S2051 includes:

Step S2051A: acquiring the number of first associated users, in which the number of the first associated users is the larger value of the capacity of the pairing table corresponding to first relationship data and the preset number corresponding to second relationship data.

Step S2051B: determining the number of the target associated users according to a sum of the number of the first associated users and the capacity of the non-pairing table corresponding to the first relationship data.

The pairing table corresponding to the first relationship data includes pairing records of the user names and the associated user avatars which are recorded in pairs, and the capacity of the pairing table is the number of the pairing records of the user names and the associated user avatars which are recorded in pairs; the preset number corresponding to the first relationship data is the number of image frames corresponding to the dynamic image; the capacity and the preset number of the pairing table are the numbers of associated users which correspond to the two image models respectively and include complete association relationship information (the user name and associated user avatar), and the larger one of the two is determined as a first associated user number so as to obtain the number covering the association relationship information required for generating the effect images corresponding to the two image models; then, the capacity of the non-pairing table corresponding to the first relationship data is acquired, for example, the number of second associated users; and finally the sum of the number of the first associated users and the number of the second associated users are computed to obtain the number of the target associated users. The non-pairing table corresponding to the first relationship data includes non-pairing user information (namely independent user name or associated user avatar); and the non-pairing user information needs to be used in response to the effect image being of the type of single-frame image being generated, so that the required final number of the target associated users (the generated association relationship list) can cover this part of user information.

The number of the target associated users obtained in the steps in this embodiment is equivalent to the minimum number of associated users required for realizing effect images corresponding to two image models. Compared with the association relationship list generated directly using the number of all associated users of the current user, the association relationship list generated based on the number of the target associated users occupies less memory space and system resources, so that the effect image loading speed is increased.

It is to be noted that based on the above introduction, because the first relationship data and the second relationship data are determined according to the association relationship resource object and the corresponding image model, in S203-S205, namely, the specific implementation mode of the number of the corresponding target associated users is determined according to the association relationship resource object and the corresponding image model.

Exemplarily, after the number of the target associated users is obtained, the associated users with the target associated user number are selected from all the associated users in a random or other specific mode, for example, according to parameters such as intimacy and communication frequency (of the current user and the associated user), thus the association relationship list is obtained, and the specific implementation mode is introduced in the previous embodiments, which is not described in detail here.

Step S206: acquiring corresponding association relationship information from the server based on the association relationship list.

Step S207: generating the corresponding effect image based on the association relationship information.

Exemplarily, after the association relationship list is obtained, the corresponding association relationship information is downloaded from the server for the associated user represented by the association relationship list, and then the corresponding effect image is generated based on the association relationship information. The specific implementation mode is introduced in the previous embodiments and is not described in detail here. In a possible implementation mode, in response to a valid image being not obtained utilizing the custom asset file through the above steps, for example, the current user has no associated user, or the number of all the associated users of the current user is too small, the corresponding effect image is generated by replacing a preset basic picture, and the specific implementation process and steps are not described in detail.

Optionally, after the corresponding effect image is generated, the method further includes:

Step S208: generating a target video based on the effect image, and releasing the target video.

Step S209: after the target video is released, acquiring at least one piece of target association relationship information, in which the target association relationship information is the association relationship information corresponding to a target effect image displayed in a target display pose in the target video.

Exemplarily, after the effect image is obtained based on the above steps, the effect image is rendered into the original video, thus the corresponding target video can be obtained, and the specific implementation process is the prior art and is not described in detail. Then, in response to a user instruction or logic preset by the application, the target video can be further released, namely the target video is released to the application or platform, so that other users can view the target video. Then, the terminal device acquires one target effect image in the displayed effect images of the target video, the target effect image is the effect image displayed in the specific target display pose, and the association relationship information corresponding to the target effect image is the target association relationship information.

Specifically, the steps of the embodiments above can be applied to the following specific application scenes:
in activity scenes such as drawing lots by users of the platform, randomly selecting lucky fans, etc.; based on the target effect, a plurality of single-frame pictures can be dynamically displayed in the target video, or the visual effect of the sequence frame is displayed, that is, the effect images (such as pictures including the avatars and nicknames of associated users) generated by the association relationship information of different associated users can move and/or rotate in the target video; and finally, one target effect image is randomly selected from the plurality of effect images of the target video, displayed in a specific position and pose to indicate that the effect image (the corresponding associated user) is selected. Therefore, the activities such as drawing lots by the users of the platform and randomly selecting the lucky fans are realized. The “randomly selected” associated user is the target associated user, and correspondingly, the association relationship information corresponding to the target associated user is the target association relationship information.

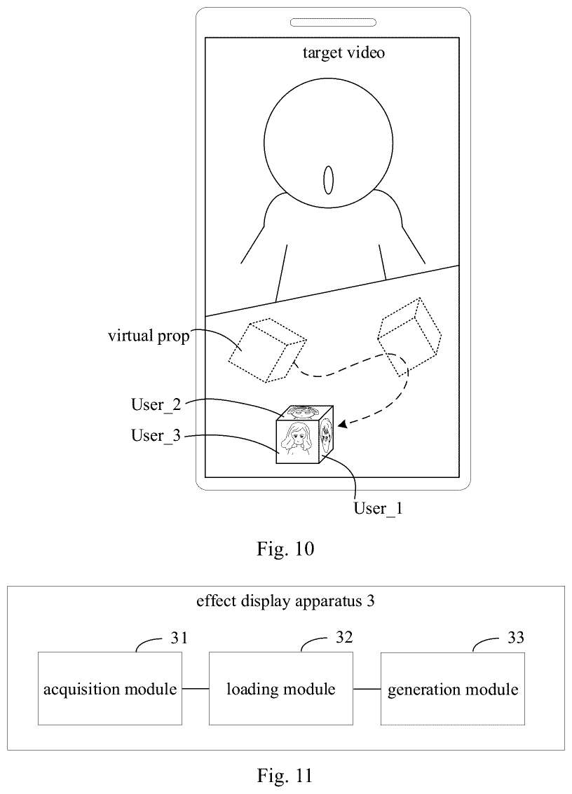

FIG. 10 is a schematic diagram of target association relationship information provided by an embodiment of the present disclosure; as shown in FIG. 9, the target video, generated by adding the target effect to the original video, includes a cube-model virtual prop, and meanwhile, the effect image generated based on the association relationship information includes the avatars of 6 associated users, which are correspondingly set on six surfaces of the virtual prop (only 3 surfaces are shown in the figure and correspond to association relationship information User_1, User_2 and User_3). In response to the target effect being triggered, the virtual prop appears in the video, and simulates a real physical collision rule to roll and move randomly, then the effect images located on the 6 surfaces of the virtual prop rotate and move along with the virtual prop, and after the virtual prop stops, the association relationship information (shown as User_3 in the figure) corresponding to the effect images facing the lens side is determined as the target association relationship information. The process is an imaged random extraction process, and the specific implementation principle and mode are not described in detail.

It is to be noted that under the random drawing activity scenes such as drawing the lots by the users of the platform, and randomly selecting the lucky fans, there are multiple specific implementation processes for randomly selecting a selected target platform user (target associated user) from multiple users of the platform (associated users), for example, the random selection process, the effect model and the like can be set based on needs; and the above embodiment is only configured to illustratively show the determination mode of the target association relationship information.

Step S210: transmitting hit information to the server based on the target association relationship information, in which the hit information is configured to enable the server to transmit a notification message to the target associated user corresponding to the target association relationship information.

Exemplarily, the randomly selected result, namely the target user information determined in the above step, is notified to the corresponding target associated user, the specific implementation mode is that the terminal device transmits the hit information to the server, and the hit information includes an identifier indicating the target user information; and the server transits a notification message to the corresponding target associated user according to the hit information, then the target associated user displays or broadcasts the notification message after receiving the notification message, thereby achieving the purpose of hit prompt.

Exemplarily, the hit information includes at least one of the following: an identification identifier of the current user, an identification identifier of the target effect, and target video release time.

According to this embodiment, in the scene of random selecting, the result of random selecting carried out based on the target effect is transmitted to the hit user (the target associated user), which realizes better social attributes of the target effect and improves the social effect.

Optionally, in another possible implementation mode, after step S202, the method further includes:

Step S208A: obtaining a notification toggle state by loading the custom asset file.

Step S208B: in response to the toggle state being the target state, executing step S209.

Exemplarily, on the other hand, the custom asset file can be loaded to obtain the notification toggle state, and the notification toggle is a toggle module configured to set whether to transmit a notification to the target associated user (hit user) in the above step. In one possible implementation mode, the notification toggle has a first state and a second state, the first state represents that the function is started, and the second state represents that the function is stopped; under this condition, the first state is a target state, and in response to the toggle state being the first state, step S210 is executed, namely, hit information is transmitted to the server based on the target association relationship information; otherwise, in response to the toggle state being the second state, the operation is ended, and the hit message is not transmitted any more.

The notification toggle state can be a parameter set based on a user instruction; and after the custom asset file is loaded, the notification toggle state is obtained through an interface provided by an association relationship resource unit, and the above determination step is executed, that is, the custom asset file provides the capability of acquiring the notification toggle state, so that the terminal device can load the custom asset file to obtain the notification toggle state, and the specific implementation process is not described in detail.

In this embodiment, the implementation mode of step S201 is the same as the implementation mode of step S101 in the embodiment shown in FIG. 2, which is not described one by one here.

Corresponding to the effect display method in the above embodiment, FIG. 11 is a structural block diagram of an effect display apparatus provided by an embodiment of the present disclosure. In order to facilitate description, only parts related to this embodiment of the present disclosure are shown. As shown in FIG. 10, an effect display apparatus 3 includes:
an acquisition module 31, which is configured to: in response to triggering of a target effect, acquire a corresponding custom asset file, in which the target effect is configured to display at least one frame of effect image;
a loading module 32, which is configured to load the custom asset file through a resource reference interface of the target effect to obtain an association relationship list corresponding to the target effect, and acquire corresponding association relationship information from a server based on the association relationship list, and the association relationship information represents a user identifier of an associated user having an association relationship with the current user; and
a generation module 33, which is configured to generate a corresponding effect image based on the association relationship information.

In one embodiment of the present disclosure, in response to loading the custom asset file through the resource reference interface of the target effect to obtain the association relationship list corresponding to the target effect, the loading module 32 is specifically configured to: load the custom asset file from the project file corresponding to the target effect through the resource reference interface of the target effect, so as to obtain at least one association relationship resource object and an image model corresponding to the association relationship resource object, in which the association relationship resource object is configured to provide association relationship information for the effect image corresponding to the image model; and obtain the association relationship list corresponding to the target effect according to the association relationship resource object and the corresponding image model.

In one embodiment of the present disclosure, in response to obtaining the association relationship list corresponding to the target effect according to the association relationship resource object and the corresponding image model, the loading module 32 is specifically configured to: in response to the image model being the single-frame image, access a first attribute of the association relationship resource object to obtain first relationship data indicating the associated user, in which the first relationship data includes a first identifier and a corresponding second identifier, the first identifier represents an associated user name of the associated user, and the second identifier represents an associated user avatar of the associated user; and generate the association relationship list corresponding to the target effect according to the first relationship data.

In one embodiment of the present disclosure, in response to accessing the first attribute of the association relationship resource object to obtain the first relationship data indicating the associated user, the loading module 32 is specifically configured to: access the first attribute of the association relationship resource object, and acquire at least one first identifier and at least one second identifier; store the first identifier and the second identifier with the same identification information in a paired mode to obtain a pairing table containing at least one pairing record; and generate the first relationship data according to the pairing table.

In one embodiment of the present disclosure, the loading module 32 is further configured to: independently store the first identifier or the second identifier respectively which do not have the same identification information so as to obtain a non-pairing table; and in response to the loading module 32 generating the first relationship data according to the pairing table, the loading module 32 is specifically configured to: generate the first relationship data according to the pairing table and the non-pairing table.

In one embodiment of the present disclosure, in response to obtaining the association relationship list corresponding to the target effect according to the association relationship resource object and the corresponding image model, the loading module 32 is specifically configured to: in response to the image model being the dynamic image, access a second attribute of the association relationship resource object to obtain second relationship data indicating the associated user, in which the second relationship data includes a preset number of third identifiers, the third identifier corresponds to the user information of the associated user, and the preset number is the number of image frames of the dynamic image; and generate the association relationship list corresponding to the target effect according to the second relationship data.

In one embodiment of the present disclosure, in response to obtaining the association relationship list corresponding to the target effect according to the association relationship resource object and the corresponding image model, the loading module 32 is specifically configured to: determine the number of the corresponding target associated users according to the association relation resource object and the corresponding image model; and obtain the association relationship list corresponding to the target effect according to the number of the target associated users.

In one embodiment of the present disclosure, in response to determining the number of corresponding the target associated users according to the association relationship resource object and its corresponding image model, the loading module 32 is specifically configured to: acquire the number of first associated users, in which the number of the first associated users is the larger value of the capacity of the pairing table corresponding to first relationship data and the preset number corresponding to second relationship data; and determine the number of target associated users according to the sum of the number of the first associated users and the capacity of the non-pairing table corresponding to the first relationship data.

In one embodiment of the present disclosure, in response to obtaining corresponding association relationship information from the server based on the association relationship list, the loading module 32 is specifically configured to: acquire a target association relationship type, and determine a target association relationship list from at least two association relationship lists; and based on the target association relationship list, acquire corresponding association relationship information from the server.

In one embodiment of the present disclosure, after generating the corresponding effect image based on the association relationship information, the loading module 32 is further configured to: generate a target video based on the effect image; after the target video is released, acquire at least one piece of target association relationship information, in which the target association relationship information is the association relationship information corresponding to the target effect image displayed in a target display pose in the target video; and transmit hit information to the server based on the target association relationship information, in which the hit information is configured to enable the server to transmit a notification message to the target associated user corresponding to the target association relationship information.

In one embodiment of the present disclosure, the loading module 32 is further configured to: obtain a notification toggle state by loading the custom asset file; and in response to the generation module 33 transmitting hit information to the server based on the target association relationship information, the generation module 33 is specifically configured to: transmit the hit information to the server based on the target association relationship information in response to the toggle state being the target state.

In one embodiment of the present disclosure, the hit information includes at least one of the following: an identification identifier of the current user, an identification identifier of the target effect, and target video release time.

The acquisition module 31, the loading module 32 and the generation module 33 are sequentially connected. The effect display apparatus 3 according to this embodiment can execute the technical solutions of the above method embodiments, the implementation principle and the technical effect are similar, which are not described in detail in this embodiment.

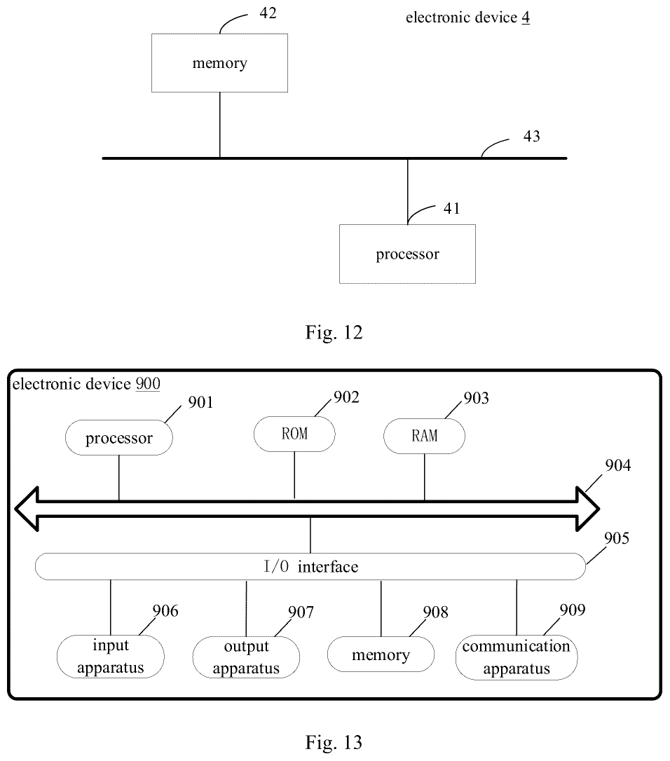

FIG. 12 is a structural schematic diagram of an electronic device provided by an embodiment of the present disclosure, and as shown in FIG. 12, the electronic device 4 includes:
a processor 41, and a memory 42 in communication connection with the processor 41;
in which the memory 42 stores a computer execution instruction; and
the processor 41 executes the computer execution instruction stored in the memory 42 to implement the effect display method in the embodiments shown in FIG. 2-FIG. 10.

Optionally, the processor 41 and the memory 42 are connected through a bus 43.

Related descriptions can be understood referring to corresponding related descriptions and effects in the steps in the corresponding embodiments in FIG. 2-FIG. 10, which are not described in detail here.

An embodiment of the present disclosure provides a computer-readable storage medium, the computer-readable storage medium stores a computer execution instruction that, when executed by a processor, causes the processor to implement the effect display method provided by any one of the corresponding embodiments in FIG. 2-FIG. 10 in response to being executed by a processor.

In order to achieve above embodiments, an embodiment of the present disclosure further provides an electronic device.

Referring to FIG. 13, it shows a structural schematic diagram of an electronic device 900 suitable for implementing the embodiment of the present disclosure, which may be a terminal device or a server. The terminal device may include, but is not limited to, a mobile terminal such as a mobile phone, a notebook computer, a digital broadcasting receiver, a personal digital assistant (PDA), a portable Android device (PAD), a portable media player (PMP), a vehicle-mounted terminal (for example, a vehicle-mounted navigation terminal) and so on, and a fixed terminal such as a digital TV, a desktop computer and so on. The electronic device illustrated in the FIG. 13 is only an example, and should not pose any limitation to the functions and the scope of use of the embodiments of the present disclosure.

As shown in FIG. 13, the electronic device 900 may include a processor (for example, a central processor, a graphics processor, and so on) 901 that may execute various appropriate actions and processes according to a program stored in a read only memory (ROM) 902 or a program loaded from a random-access memory (RAM) 903 from a memory 908. In the RAM 903, various programs and data required for the operation of the electronic device 900 are further stored. The processor 901, the ROM 902 and the RAM 903 are interconnected by a bus 904. An input/output (I/O) interface 905 is also connected to the bus 904.

Generally, the following devices may be connected to the I/O interface 905: an input apparatus 906 including, for example, a touch screen, a touch pad, a keyboard, a mouse, a camera, a microphone, an accelerometer, a gyroscope, etc.; an output apparatus 907 including, for example, a liquid crystal display (LCD), a loudspeaker, a vibrator, etc.; a memory 908 including, for example, a magnetic tape, a hard disk, etc.; and a communication apparatus 909. The communication apparatus 909 may allow the electronic device 900 to perform wireless or wired communication with other devices to exchange data. While the electronic device 900 with various devices is illustrated in FIG. 13, it should be understood that it is not required to implement or have all the apparatuses illustrated. It may implement alternatively or possess the more or less apparatuses.

In particular, according to the embodiments of the present disclosure, the processes described above with reference to the flowcharts may be implemented as a computer software program. For example, an embodiment of the present disclosure includes a computer program product, which includes a computer program carried by a computer-readable medium, the computer program includes program codes for performing the method illustrated in the flowchart. In such an embodiment, the computer program may be downloaded and installed from a network through the communication apparatus 909, or installed from the memory 908, or installed from the ROM 902. In response to the computer program being executed by the processor 901, the above-mentioned functions defined in the method of the embodiments of the present disclosure are performed.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random-access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, an apparatus or a device. The program codes contained on the computer-readable medium may be transmitted by any suitable medium, including but not limited to: an electric wire, a fiber-optic cable, radio frequency (RF) and so on, or any suitable combination of the above.

The computer-readable medium described above may be included in the above-mentioned electronic device; or it may exist alone without being assembled into the electronic device.

The computer-readable medium carries one or more programs, that, in response to being executed by the electronic device, cause the electronic device to perform the method illustrated in the above embodiments.

Computer program codes for performing the operations of the present disclosure may be written in one or more programming languages or a combination thereof, the programming languages include object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving a remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. Among them, the name of the unit does not constitute a limitation on the unit itself in some cases. For example, a first acquisition unit can also be described as “a unit that acquires at least two Internet protocol addresses”.

The functions described above herein may be at least partially performed by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logic device (CPLD) and so on.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, an effect display method is provided, which includes:
in response to triggering of a target effect, acquiring a corresponding custom asset file, in which the target effect is configured to display at least one frame of effect image, the effect image is an image generated based on association relationship information of a current user, and the association relationship information represents a user identifier of an associated user having an association relationship with the current user; loading the custom asset file through a resource reference interface of the target effect to obtain an association relationship list corresponding to the target effect, and acquiring corresponding association relationship information from a server based on the association relationship list; and generating a corresponding effect image based on the association relationship information.

According to one or more embodiments of the present disclosure, loading the custom asset file through the resource reference interface of the target effect to obtain the association relationship list corresponding to the target effect, includes: loading the custom asset file from the project file corresponding to the target effect through the resource reference interface of the target effect, so as to obtain at least one association relationship resource object and an image model corresponding to each of the at least one association relationship resource object, in which the association relationship resource object is configured to provide the association relationship information for the effect image corresponding to the image model; and obtaining the association relationship list corresponding to the target effect according to the association relationship resource object and the corresponding image model.

According to one or more embodiments of the present disclosure, obtaining the association relationship list corresponding to the target effect according to the association relationship resource object and the corresponding image model, includes: in response to the image model being a single-frame image, accessing a first attribute of the association relationship resource object to obtain first relationship data indicating the associated user, in which the first relationship data includes a first identifier and a corresponding second identifier, the first identifier represents an associated user name of the associated user, and the second identifier represents an associated user avatar of the associated user; and generating the association relationship list corresponding to the target effect according to the first relationship data.

According to one or more embodiments of the present disclosure, accessing the first attribute of the association relationship resource object to obtain first relationship data indicating the associated user, includes: through accessing the first attribute of the association relationship resource object, acquiring at least one first identifier and at least one second identifier; storing the first identifier and the second identifier with the same identification information in a paired mode to obtain a pairing table containing at least one pairing record; and generating the first relationship data according to the pairing table.

According to one or more embodiments of the present disclosure, the method further includes: independently storing the first identifier or the second identifier respectively which does not have the same identification information to obtain a non-pairing table; and generating the first relationship data according to the pairing table, includes: generating the first relationship data according to the pairing table and the non-pairing table.

According to one or more embodiments of the present disclosure, obtaining the association relationship list corresponding to the target effect according to the association relationship resource object and the corresponding image model, includes: in response to the image model being a dynamic image, accessing a second attribute of the association relationship resource object to obtain second relationship data indicating the associated user, in which the second relationship data includes a preset number of third identifiers, each of the preset number of third identifiers corresponds to user information of the associated user, and the preset number is the number of image frames of the dynamic image; and generating the association relationship list corresponding to the target effect according to the second relationship data.

According to one or more embodiments of the present disclosure, obtaining the association relationship list corresponding to the target effect according to the association relationship resource object and the corresponding image model, includes: determining a number of the corresponding target associated users according to the association relationship resource object and the corresponding image model; and obtaining the association relationship list corresponding to the target effect according to the number of the target associated users.

According to one or more embodiments of the present disclosure, determining the number of the corresponding target associated users according to the association relationship resource object and the corresponding image model, includes: acquiring the number of first associated users, in which the number of the first associated users is a larger value of a capacity of the pairing table corresponding to first relationship data and a preset number corresponding to second relationship data; and determining the number of the target associated users according to the sum of the number of the first associated users and the capacity of the non-pairing table corresponding to the first relationship data.

According to one or more embodiments of the present disclosure, acquiring corresponding association relationship information from the server based on the association relationship list, includes: acquiring a target association relationship type, and determining a target association relationship list from at least two association relationship lists; and based on the target association relationship list, acquiring corresponding association relationship information from the server.

According to one or more embodiments of the present disclosure, after generating the corresponding effect image based on the association relationship information, it further includes: generating a target video based on the effect image; after the target video is released, acquiring at least one piece of target association relationship information, each of the at least one piece of target association relationship information is the association relationship information corresponding to a target effect image displayed in a target display pose in the target video; and transmitting hit information to the server based on the target association relationship information, in which the hit information is configured to enable the server to transmit a notification message to a target associated user corresponding to the target association relationship information.

According to one or more embodiments of the present disclosure, it further includes: obtaining a notification toggle state by loading the custom asset file; and transmitting hit information to the server based on the target association relationship information, includes: transmitting the hit information to the server based on the target association relationship information in response to the toggle state being a target state.

According to one or more embodiments of the present disclosure, the hit information includes at least one of the following: an identification identifier of the current user, an identification identifier of the target effect, and target video release time.

According to one or more embodiments of the present disclosure, an effect display apparatus is provided, which includes:
an acquisition module, which is configured to: in response to triggering of a target effect, acquire a corresponding custom asset file, in which the target effect is configured to display at least one frame of effect image, the effect image is an image generated based on association relationship information of a current user, and the association relationship information represents a user identifier of an associated user having an association relationship with the current user;
a loading module, which is configured to load the custom asset file through a resource reference interface of the target effect to obtain an association relationship list corresponding to the target effect, and acquire corresponding association relationship information from a server based on the association relationship list; and
a generation module, which is configured to generate a corresponding effect image based on the association relationship information.

According to one or more embodiments of the present disclosure, in response to loading the custom asset file through the resource reference interface of the target effect to obtain the association relationship list corresponding to the target effect, the loading module is specifically configured to: load the custom asset file from the project file corresponding to the target effect through the resource reference interface of the target effect, so as to obtain at least one association relationship resource object and an image model corresponding to the association relationship resource object, in which the association relationship resource object is configured to provide association relationship information for the effect image corresponding to the image model; and obtain the association relationship list corresponding to the target effect according to the association relationship resource object and the corresponding image model.

According to one or more embodiments of the present disclosure, in response to obtaining the association relationship list corresponding to the target effect according to the association relationship resource object and the corresponding image model, the loading module is specifically configured to: in response to the image model being the single-frame image, access a first attribute of the association relationship resource object to obtain first relationship data indicating the associated user, in which the first relationship data includes a first identifier and a corresponding second identifier, the first identifier represents an associated user name of the associated user, and the second identifier represents an associated user avatar of the associated user; and generate the association relationship list corresponding to the target effect according to the first relationship data.

According to one or more embodiments of the present disclosure, in response to accessing the first attribute of the association relationship resource object to obtain the first relationship data indicating the associated user, the loading module is specifically configured to: access the first attribute of the association relationship resource object, and acquire at least one first identifier and at least one second identifier; store the first identifier and the second identifier with the same identification information in a paired mode to obtain a pairing table containing at least one pairing record; and generate the first relationship data according to the pairing table.

According to one or more embodiments of the present disclosure, the loading module is further configured to: independently store the first identifier or the second identifier respectively which do not have the same identification information so as to obtain a non-pairing table; and in response to the loading module generating the first relationship data according to the pairing table, the loading module is specifically configured to: generate the first relationship data according to the pairing table and the non-pairing table.

According to one or more embodiments of the present disclosure, in response to obtaining the association relationship list corresponding to the target effect according to the association relationship resource object and the corresponding image model, the loading module is specifically configured to: in response to the image model being the dynamic image, access a second attribute of the association relationship resource object to obtain second relationship data indicating the associated user, in which the second relationship data includes a preset number of third identifiers, the third identifier corresponds to the user information of the associated user, and the preset number is the number of image frames of the dynamic image; and generate the association relationship list corresponding to the target effect according to the second relationship data.

According to one or more embodiments of the present disclosure, in response to obtaining the association relationship list corresponding to the target effect according to the association relationship resource object and the corresponding image model, the loading module is specifically configured to: determine the number of the corresponding target associated users according to the association relation resource object and the corresponding image model; and obtain the association relationship list corresponding to the target effect according to the number of the target associated users.

According to one or more embodiments of the present disclosure, in response to determining the number of the corresponding target associated users according to the association relationship resource object and the corresponding image model, the loading module is specifically configured to: acquire the number of first associated users, in which the number of the first associated users is the larger value of the capacity of the pairing table corresponding to first relationship data and the preset number corresponding to second relationship data; and determine the number of target associated users according to the sum of the number of the first associated users and the capacity of the non-pairing table corresponding to the first relationship data.

According to one or more embodiments of the present disclosure, in response to obtaining corresponding association relationship information from the server based on the association relationship list, the loading module is specifically configured to: acquire a target association relationship type, and determine a target association relationship list from at least two association relationship lists; and based on the target association relationship list, acquire corresponding association relationship information from the server.

According to one or more embodiments of the present disclosure, after generating the corresponding effect image based on the association relationship information, the loading module is further configured to: generate a target video based on the effect image; after the target video is released, acquire at least one piece of target association relationship information, in which the target association relationship information is the association relationship information corresponding to the target effect image displayed in a target display pose in the target video; and transmit hit information to the server based on the target association relationship information, in which the hit information is configured to enable the server to transmit a notification message to the target associated user corresponding to the target association relationship information.

According to one or more embodiments of the present disclosure, the loading module is further configured to: obtaining a notification toggle state by loading the custom asset file; and in response to the generation module transmitting hit information to the server based on the target association relationship information, the generation module is specifically configured to: transmit the hit information to the server based on the target association relationship information in response to the toggle state being the target state.

According to one or more embodiments of the present disclosure, the hit information includes at least one of the following: an identification identifier of the current user, an identification identifier of the target effect, and target video release time.

According to one or more embodiments of the present disclosure, an electronic device is provided, which includes at least one processor and a memory, the memory stores a computer execution instruction; and the least one processor executes the computer execution instruction stored in the memory to implement the above effect display method and various possible designed effect display methods of the above effect display method.

According to one or more embodiments of the present disclosure, a computer-readable storage medium is provided, the computer-readable storage medium stores a computer execution instruction that, when executed by a processor, causes the processor to implement the above effect display method and various possible designed effect display methods of the above effect display method.

According to one or more embodiments of the present disclosure, a computer program product is provided, the computer program product includes a computer program that, when executed by a processor, causes the processor to implement the above effect display method and various possible designed effect display methods of the above effect display method.

The description above is merely the preferred embodiments of the present disclosure and illustrative of the principles of the technology employed. It should be understood by those skilled in the art that the disclosure scope involved in the present disclosure is not limited to the technical solution formed by the specific combination of the above technical features, but also covers other technical solutions formed by any combination of the above technical features or their equivalent features without departing from the concept of the above disclosure, for example, technical solution that formed by replacing the above features with the technical features with similar functions disclosed in this disclosure (but not limited to).

Furthermore, although various operations are depicted in a particular order, this should not be understood as requiring that these operations be performed in the particular order illustrated or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect display method, comprising:
in response to triggering of a target effect, acquiring a corresponding custom asset file, wherein the target effect is configured to display at least one frame of effect image;
loading the custom asset file through a resource reference interface of the target effect to obtain an association relationship list corresponding to the target effect, and acquiring corresponding association relationship information from a server based on the association relationship list, and the association relationship information represents a user identifier of an associated user having an association relationship with the current user; and
generating a corresponding effect image based on the association relationship information.

2. The method according to claim 1, wherein loading the custom asset file through the resource reference interface of the target effect to obtain the association relationship list corresponding to the target effect, comprises:
loading the custom asset file from a project file corresponding to the target effect through the resource reference interface of the target effect, so as to obtain at least one association relationship resource object and an image model corresponding to each of the at least one association relationship resource object, wherein the association relationship resource object is configured to provide the association relationship information for the effect image corresponding to the image model; and
obtaining the association relationship list corresponding to the target effect according to the association relationship resource object and the corresponding image model.

3. The method according to claim 2, wherein obtaining the association relationship list corresponding to the target effect according to the association relationship resource object and the corresponding image model, comprises:
in response to the image model being a single-frame image, accessing a first attribute of the association relationship resource object to obtain first relationship data indicating the associated user, wherein the first relationship data comprises a first identifier and a corresponding second identifier, the first identifier represents an associated user name of the associated user, and the second identifier represents an associated user avatar of the associated user; and
generating the association relationship list corresponding to the target effect according to the first relationship data.

4. The method according to claim 3, wherein accessing the first attribute of the association relationship resource object to obtain the first relationship data indicating the associated user, comprises:
through accessing the first attribute of the association relationship resource object, acquiring at least one first identifier and at least one second identifier;
storing the first identifier and the second identifier with the same identification information in a paired mode to obtain a pairing table containing at least one pairing record; and
generating the first relationship data according to the pairing table.

5. The method according to claim 4, further comprising:
independently storing the first identifier or the second identifier respectively which does not have the same identification information to obtain a non-pairing table;
wherein generating the first relationship data according to the pairing table, comprises:
generating the first relationship data according to the pairing table and the non-pairing table.

6. The method according to claim 2, wherein obtaining the association relationship list corresponding to the target effect according to the association relationship resource object and the corresponding image model, comprises:
in response to the image model being a dynamic image, accessing a second attribute of the association relationship resource object to obtain second relationship data indicating the associated user, wherein the second relationship data comprises a preset number of third identifiers, each of the preset number of third identifiers corresponds to user information of the associated user, and the preset number is the number of image frames of the dynamic image; and
generating the association relationship list corresponding to the target effect according to the second relationship data.

7. The method according to claim 5, wherein obtaining the association relationship list corresponding to the target effect according to the association relationship resource object and the corresponding image model, comprises:
determining a number of the corresponding target associated users according to the association relationship resource object and the corresponding image model; and
obtaining the association relationship list corresponding to the target effect according to the number of the target associated users.

8. The method according to claim 7, wherein determining the number of the corresponding target associated users according to the association relationship resource object and the corresponding image model, comprises:
acquiring the number of first associated users, wherein the number of the first associated users is a larger value of a capacity of the pairing table corresponding to first relationship data and a preset number corresponding to second relationship data; and
determining the number of the target associated users according to a sum of the number of the first associated users and the capacity of the non-pairing table corresponding to the first relationship data.

9. The method according to claim 1, wherein acquiring the corresponding association relationship information from the server based on the association relationship list, comprises:
acquiring a target association relationship type, and determining a target association relationship list from at least two association relationship lists; and
based on the target association relationship list, acquiring the corresponding association relationship information from the server.

10. The method according to claim 1, wherein, after generating the corresponding effect image based on the association relationship information, the method further comprises:
generating a target video based on the effect image;
after the target video is released, acquiring at least one piece of target association relationship information, wherein each of the at least one piece of target association relationship information is the association relationship information corresponding to a target effect image displayed in a target display pose in the target video; and
transmitting hit information to the server based on the target association relationship information, wherein the hit information is configured to enable the server to transmit a notification message to a target associated user corresponding to the target association relationship information.

11. The method according to claim 10, further comprising:
obtaining a notification toggle state by loading the custom asset file; and
wherein transmitting the hit information to the server based on the target association relationship information, comprises:
transmitting the hit information to the server based on the target association relationship information in response to the toggle state being a target state.

12. The method according to claim 10, wherein the hit information comprises at least one of the following:
an identification identifier of the current user, an identification identifier of the target effect, and target video release time.

13. An electronic device, comprising: a processor and a memory;
wherein the memory stores a computer execution instruction; and
the processor executes the computer execution instruction stored in the memory to implement:
in response to triggering of a target effect, acquiring a corresponding custom asset file, wherein the target effect is configured to display at least one frame of effect image;
loading the custom asset file through a resource reference interface of the target effect to obtain an association relationship list corresponding to the target effect, and acquiring corresponding association relationship information from a server based on the association relationship list, and the association relationship information represents a user identifier of an associated user having an association relationship with the current user; and
generating a corresponding effect image based on the association relationship information.

14. The electronic device according to claim 13, the processor executes the computer execution instruction stored in the memory to further implement:
loading the custom asset file from a project file corresponding to the target effect through the resource reference interface of the target effect, so as to obtain at least one association relationship resource object and an image model corresponding to each of the at least one association relationship resource object, wherein the association relationship resource object is configured to provide the association relationship information for the effect image corresponding to the image model; and
obtaining the association relationship list corresponding to the target effect according to the association relationship resource object and the corresponding image model.

15. The electronic device according to claim 14, the processor executes the computer execution instruction stored in the memory to further implement:
in response to the image model being a single-frame image, accessing a first attribute of the association relationship resource object to obtain first relationship data indicating the associated user, wherein the first relationship data comprises a first identifier and a corresponding second identifier, the first identifier represents an associated user name of the associated user, and the second identifier represents an associated user avatar of the associated user; and
generating the association relationship list corresponding to the target effect according to the first relationship data.

16. The electronic device according to claim 15, the processor executes the computer execution instruction stored in the memory to further implement:
through accessing the first attribute of the association relationship resource object, acquiring at least one first identifier and at least one second identifier;
storing the first identifier and the second identifier with the same identification information in a paired mode to obtain a pairing table containing at least one pairing record; and
generating the first relationship data according to the pairing table.

17. The electronic device according to claim 16, the processor executes the computer execution instruction stored in the memory to further implement:
independently storing the first identifier or the second identifier respectively which does not have the same identification information to obtain a non-pairing table;
wherein generating the first relationship data according to the pairing table, comprises:
generating the first relationship data according to the pairing table and the non-pairing table.

18. The electronic device according to claim 14, the processor executes the computer execution instruction stored in the memory to further implement:
in response to the image model being a dynamic image, accessing a second attribute of the association relationship resource object to obtain second relationship data indicating the associated user, wherein the second relationship data comprises a preset number of third identifiers, each of the preset number of third identifiers corresponds to user information of the associated user, and the preset number is the number of image frames of the dynamic image; and
generating the association relationship list corresponding to the target effect according to the second relationship data.

19. The electronic device according to claim 17, the processor executes the computer execution instruction stored in the memory to further implement:
determining a number of the corresponding target associated users according to the association relationship resource object and the corresponding image model; and
obtaining the association relationship list corresponding to the target effect according to the number of the target associated users.

20. A computer-readable storage medium, wherein the computer-readable storage medium stores a computer execution instruction that, when executed by a processor, causes the processor to implement:
in response to triggering of a target effect, acquiring a corresponding custom asset file, wherein the target effect is configured to display at least one frame of effect image;
loading the custom asset file through a resource reference interface of the target effect to obtain an association relationship list corresponding to the target effect, and acquiring corresponding association relationship information from a server based on the association relationship list, and the association relationship information represents a user identifier of an associated user having an association relationship with the current user; and
generating a corresponding effect image based on the association relationship information.
